(19) United States
(12) Patent Application Publication
(10) Pub. No.: US 2026/0224010 A1
(43) Pub. Date: Aug. 6, 2026

(54) COSMETIC BOTTLE CREAM STIRRING AND MIXING STRUCTURE

(71) Applicant: GUANGDONG EFA PACKAGING INDUSTRIAL CO.,LTD., Shantou (CN)

(72) Inventor: Xusen LI, Shantou (CN)

(73) Assignee: GUANGDONG EFA PACKAGING INDUSTRIAL CO.,LTD., Shantou (CN)

(21) Appl. No.: 19/186,922

(22) Filed: Apr. 23, 2025

(30) Foreign Application Priority Data
Feb. 6, 2025 (CN) 2025201837623

(51) Int. Cl. A45D 40/26

(52) U.S. Cl. CPC A45D 40/264; A45D 40/265

(57) ABSTRACT

The present disclosure discloses a cosmetic bottle cream stirring and mixing structure,, including a bottle body. An upper end of the bottle body is connected with a cap assembly. The cap assembly is composed of an outer cap, an inner cap, and an elastic rotation structure. The outer cap is fixed to the inner cap which is threadedly connected to the screw threads. A stirring member passes through the bottle body and the inner cap, the elastic rotation structure is disposed inside the inner cap, and the elastic rotation structure is configured to drive the stirring member to rotate back and forth, thereby stirring and mixing the cosmetic cream. The cosmetic bottle cream stirring and mixing structure disclosed by the present disclosure is convenient for stirring the cosmetic cream, and is easy to operate as the stirring structure is combined with the bottle body.

### CROSS-REFERENCE TO RELATED APPLICATIONS

The application claims priority to Chinese patent application No. 2025201837623, filed on Feb. 6, 2025, the entire contents of which are incorporated herein by reference.

### TECHNICAL FIELD

The present disclosure relates to the technical field of cosmetic stirring, and in particular, to a cosmetic bottle cream stirring and mixing structure.

### BACKGROUND

Because some cosmetic cream will be layered and uneven in texture due to the factors such as temperature and environment before use, the cream needs to be stirred before use. However, the current cosmetic bottles cannot stir the cream quickly and effectively, resulting in poor use of cosmetics. For this reason, we have introduced a cosmetic bottle with a stirring function.

### SUMMARY

The present disclosure discloses a cosmetic bottle cream stirring and mixing structure, which aims to solve the technical problem that cosmetic bottles do not have a stirring function.

In order to achieve the above-mentioned purpose, the present disclosure adopts the following technical solutions:
A cosmetic bottle cream stirring and mixing structure, including a bottle body, where cosmetic cream is contained in the bottle body, an opening at an upper end of the bottle body is provided with screw threads, and the upper end of the bottle body is connected with a cap assembly;
the cap assembly is composed of an outer cap, an inner cap, and an elastic rotation structure, where the outer cap is fixed to the inner cap which is threadedly connected to the screw threads;
a stirring member passes through the bottle body and the inner cap, the elastic rotation structure is disposed inside the inner cap, and the elastic rotation structure is configured to drive the stirring member to rotate back and forth, thereby stirring and mixing the cosmetic cream;
the elastic rotation structure includes a large spring sleeved on an upper end of the stirring member, an upper end of the large spring is connected with a lifting seat, an upper end of the outer cap is elastically connected with a button configured to drive the lifting seat to move downward, and the lifting seat will not rotate during the movement and is threadedly connected to the upper end of the stirring member.

In a preferred solution, the stirring member includes a handle, an upper end of the handle is provided with a threaded end, a thread groove in an outer wall of the threaded end is in contact with an inner convex point on an inner wall of the lifting seat, and an outer convex point on an outer wall of the lifting seat is slidably connected to a limit groove in an inner wall of the inner cap.

In a preferred solution, a brush is provided at a lower end of the handle.

In a preferred solution, the handle is provided with a rib between the threaded end and the brush, a stirring ring is placed inside the bottle body, and the rib is engaged with a groove in an inner wall of the stirring ring.

In a preferred solution, a plurality of stirring blades are provided on an outer peripheral surface of the stirring ring.

In a preferred solution, a sealing ring is provided between the handle and the inner cap.

In a preferred solution, a small spring is provided between the button and the threaded end.

In a preferred solution, a bottom stirring wheel is placed inside the bottle body and disposed at the bottom of the bottle body, connecting clamps are provided at the bottom of the stirring ring and embedded in the bottom stirring wheel, and the stirring ring rotates to drive the bottom stirring wheel to rotate synchronously.

In a preferred solution, the bottom stirring wheel includes a driving wheel, planetary rotating wheels, and an internal gear. The driving wheel is provided with embedding grooves, the connecting clamps are embedded in the embedding grooves, the driving wheel is disposed inside the internal gear, the planetary rotating wheels are disposed between the driving wheel and the internal gear, and the planetary rotating wheels are meshed with an outer tooth surface of the driving wheel and an inner tooth surface of the internal gear, respectively.

In a preferred solution, the planetary rotating wheels are each provided with a spur on a side away from the bottom of the bottle body.

As can be seen from the above, the present disclosure provides a cosmetic bottle cream stirring and mixing structure, in which the button can be pressed with a finger, so that the lifting seat drives the stirring member to rotate, thereby stirring the cosmetic cream inside the bottle body. As the finger is released, the lifting seat can be reset through the elasticity of the large spring, so that the stirring member can be reversed again to further stir the cosmetic cream, which is convenient to use.

### BRIEF DESCRIPTION OF DRAWINGS

FIG. 1 is a schematic diagram of an appearance structure of a cosmetic bottle cream stirring and mixing structure provided by the present disclosure.

FIG. 2 is a schematic diagram of a cross-sectional structure of a cosmetic bottle cream stirring and mixing structure provided by the present disclosure.

FIG. 3 is a schematic diagram of a bottle body in an open state of a cosmetic bottle cream stirring and mixing structure provided by the present disclosure.

FIG. 4 is a schematic structural diagram of a stirring ring of a cosmetic bottle cream stirring and mixing structure provided by the present disclosure.

FIG. 5 is an exploded schematic structural diagram of a cosmetic bottle cream stirring and mixing structure provided by the present disclosure.

FIG. 6 is a schematic structural diagram of a bottom stirring wheel of a cosmetic bottle cream stirring and mixing structure provided by the present disclosure.

FIG. 7 is an exploded schematic structural diagram of the bottom stirring wheel of a cosmetic bottle cream stirring and mixing structure provided by the present disclosure.

In the drawings: 1, bottle body; 2, screw threads; 3, outer cap; 4, inner cap; 5, handle; 6, sealing ring; 7, threaded end; 8, large spring; 9, lifting seat; 10, inner convex point; 11, small spring; 12, button; 13, rib; 14, brush; 15, stirring ring; 16, groove; 17, stirring blade; 18, outer convex point; 19, limit groove; 20, bottom stirring wheel; 21, connecting clamp; 22, driving wheel; 23, planetary rotating wheel; 24, internal gear; 25, spur; 26, embedding groove.

### DETAILED DESCRIPTION OF THE EMBODIMENTS

The following will combine the drawings in the embodiments of the present disclosure to clearly and completely describe the technical solutions in the embodiments of the present disclosure. Obviously, the described embodiments are only part of the embodiments of the present disclosure, not all of them.

In the description of the present disclosure, it should be understood that the terms “upper”, “lower”, “front”, “back”, “left”, “right”, “top”, “bottom”, “inside”, “outside” and the like indicate the orientation or position relationship based on the orientation or position relationship shown in the drawings, which is only for the convenience of describing the present disclosure and simplifying the description, rather than indicating or implying that the device or element referred to must have a specific orientation, be constructed and operated in a specific orientation, and therefore cannot be understood as a limitation on the present disclosure.

A cosmetic bottle cream stirring and mixing structure disclosed by the present disclosure is mainly applied to scenes where cosmetic bottles do not have a stirring function.

### Embodiment 1

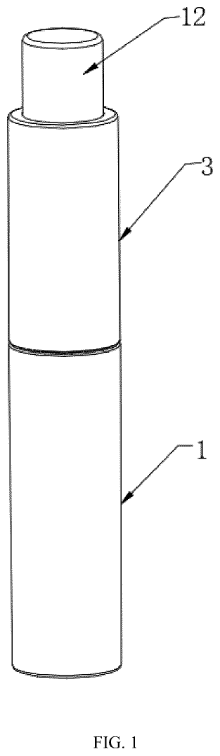

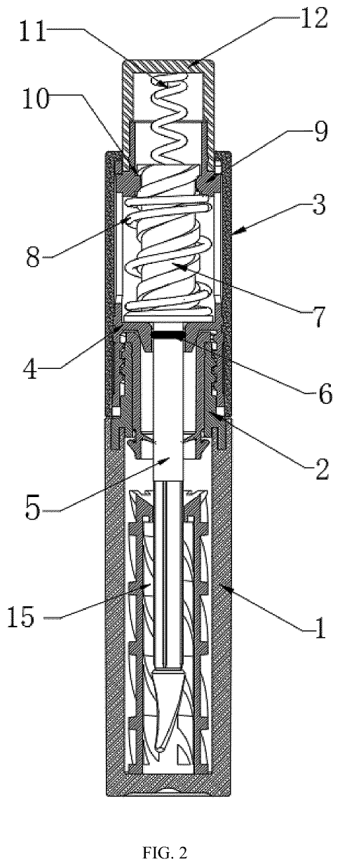

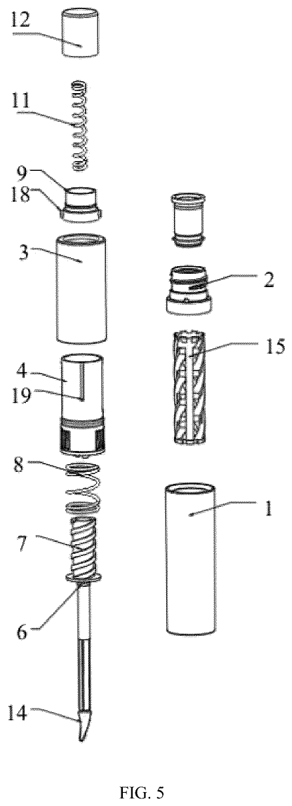

Referring to FIGS. 1 to 5, a cosmetic bottle cream stirring and mixing structure includes a bottle body 1. Cosmetic cream is contained in the bottle body 1, an opening at an upper end of the bottle body 1 is provided with screw threads 2, and the upper end of the bottle body 1 is connected with a cap assembly. The cap assembly is composed of an outer cap 3, an inner cap 4, and an elastic rotation structure. The outer cap 3 is fixed to the inner cap 4. For example, the outer cap 3 and the inner cap 4 can be firmly fixed by integrated injection molding process or a high-strength adhesive to ensure that the two will not loosen during frequent use. The inner cap 4 is threadedly connected to the screw threads 2. The accuracy level of threads is strictly controlled by using standard metric threaded connection to ensure the tightness and smoothness of the connection, thereby avoiding loosening in daily shaking.

A stirring member passes through the bottle body 1 and the inner cap 4, the elastic rotation structure is disposed inside the inner cap 4, and the elastic rotation structure is configured to drive the stirring member to rotate back and forth, thereby stirring and mixing the cosmetic cream. The elastic rotation structure includes a large spring 8 sleeved on an upper end of the stirring member. The large spring 8 is usually made of chrome vanadium spring steel, and is subjected to heat treatment processes such as hardening and tempering to optimize its modulus of elasticity and fatigue strength, ensuring that the required elastic force is provided consistently during long-term use. An upper end of the large spring 8 is connected with a lifting seat 9. The lifting seat 9 can be made of, for example, high-strength engineering plastics [polycarbonate (PC)] through precision injection molding to ensure its dimensional accuracy and mechanical properties. An upper end of the outer cap 3 is elastically connected with a button 12 configured to drive the lifting seat 9 to move downward. The surface of the button 12 is covered with skin-like material to enhance the user's feel when pressing the button. The lifting seat 9 will not rotate during the movement, which is achieved by providing, on the outer wall of the lifting seat 9, a guide key that matches the limit groove 19 in the inner wall of the inner cap 4. A clearance fit is adopted between the guide key and the limit groove 19, which can not only ensure the smooth lifting of the lifting seat 9, but also effectively limit its rotation. The lifting seat 9 is threadedly connected to the upper end of the stirring member, specifically by means of fine threads. Compared to coarse threads, fine threads can be used to realize more accurate control of the rotation angle of the stirring member under the same axial displacement, ensuring the stability and consistency of the stirring effect.

In this implementation, before the cosmetic bottle is used, the button 12 can be pressed with a finger, and the button 12 transmits the pressure precisely to the lifting seat 9 through a connection structure, so that the lifting seat 9 overcomes the elastic force of the large spring 8 and moves downwards. Since the lifting seat 9 is threadedly connected to the stirring member, the stirring member will rotate under the drive of the lifting seat 9, so as to stir the cosmetic cream inside the bottle body 1. As the finger is released, the elastic force of the large spring 8 can be released to drive the lifting seat 9 again to rise, so that the stirring member can be reversed again to further stir the cosmetic cream. After an even stirring, the outer cap 3 can be rotated to drive the inner cap 4 through fixed connection to separate from the bottle body 1, so as to facilitate the application of makeup. The surface of the outer cap 3 can be subjected to non-slip processing technology such as knurling and frosting to increase the friction with the finger and facilitate the user's operation.

Specifically, the stirring member includes a handle 5. An upper end of the handle 5 is provided with a threaded end 7, and a thread groove in an outer wall of the threaded end 7 is in contact with inner convex points 10 on an inner wall of the lifting seat 9. The handle 5 is rotated by means of the squeezing between the inner convex points 10 and the thread groove. The inner convex points 10 are evenly distributed on the inner wall of the lifting seat 9 and are in a hemispherical shape which can form a multi-point contact with the thread groove to effectively transmit torque. The outer convex points 18 on the outer wall of the lifting seat 9 are slidably connected to the limit groove 19 in the inner wall of the inner cap 4. During the lifting of the lifting seat 9, the limit groove 19 in the inner wall of the inner cap 4 can limit the outer convex points 18 and the lifting seat 9 to further ensure that the lifting seat 9 does not rotate during the lifting, thereby ensuring the stability and reliability of the entire stirring action.

Further, a brush 14 is provided at a lower end of the handle 5 and is configured to apply cosmetics. The handle 5 and the brush 14 can be integrally formed by injection molding or connected with a high-strength adhesive to ensure a firm connection.

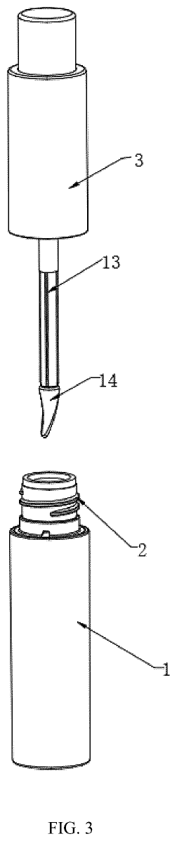

Specifically, as shown in FIG. 3, the handle 5 is provided with a rib 13 between the threaded end 7 and the brush 14, a stirring ring 15 is placed inside the bottle body 1, and the rib 13 is engaged with a groove 16 in an inner wall of the stirring ring 15. The size of the stirring ring 15 is customized according to the internal space of the bottle body 1 to ensure that the cosmetic cream can be fully covered during stirring, achieving a good stirring effect. The height of the stirring ring 15 can be adjusted according to the height of the bottle body, with a higher stirring ring being suitable for high-bodied cosmetic bottles and a shorter stirring ring being suitable for shallow-bodied cosmetic bottles, so as to avoid interference with the bottom or wall of the bottle during stirring. During the rotation of the handle 5, the stirring ring 15 can be driven to rotate by the rib 13, thereby improving the stirring uniformity of the cosmetic cream. The size of the stirring ring 15 is customized according to the internal space of the bottle body 1 to ensure that the cosmetic cream can be fully covered during stirring, achieving a good stirring effect. The height of the stirring ring 15 can be adjusted according to the height of the bottle body, with a higher stirring ring being suitable for high-bodied cosmetic bottles and a shorter stirring ring being suitable for shallow-bodied cosmetic bottles, so as to avoid interfering with the bottom or wall of the bottle during stirring.

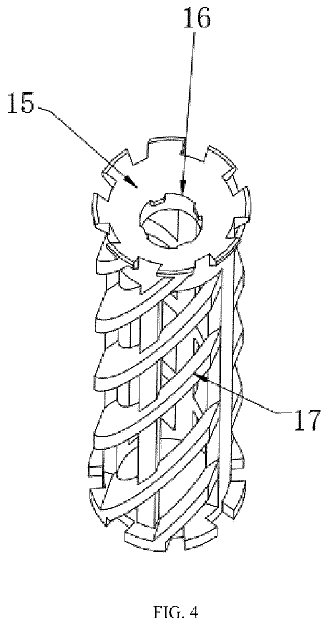

As shown in FIG. 4, several stirring blades 17 are provided on an outer peripheral surface of the stirring ring 15. The number of the stirring blades 17 is optimally configured according to the size of the cosmetic bottle and the viscosity of the cream. The number of the stirring blades 17 is appropriately increased for large-volume or high-viscosity creams.

The shape of the stirring blades 17 can be designed as arc, sawtooth or wave, etc. Stirring blades in different shapes produce different hydrodynamic effects in the stirring process. For example, arc-shaped stirring blades guide the cream to form a smooth rotating flow, which is suitable for creams of general texture; sawtooth-shaped stirring blades have a cutting effect on creams that are thicker or have granular ingredients, which enhances the stirring effect; and wave-shaped stirring blades produce a complex turbulent flow, which improves the uniformity of stirring. The way to distribute the stirring blades 17 may be designed according to the flow characteristics of the cream inside the bottle, such as providing more or denser stirring blades 17 near the wall of the bottle to enhance the stirring of the cream near the wall of the bottle. Alternatively, a plurality of layers of the stirring blades 17 may be designed, with different layers of stirring blades having different shapes and angles to further enhance the comprehensiveness and uniformity of the stirring.

Further, a sealing ring 6 is provided between the handle 5 and the inner cap 4, which can prevent the cosmetic cream from penetrating into the inner cap 4. The sealing ring 6 is generally made of nitrile rubber, and is treated with a special vulcanization process to improve its hardness, abrasion resistance and sealing performance. The sealing ring 6 can be designed as an O-shape or a lip shape according to the connection portion between the handle 5 and the inner cap 4. In order to further improve the sealing performance, the surface of the sealing ring 6 can be coated with silicone oil coating of a low friction coefficient to reduce the friction with the handle 5 and enhance the sealing effect.

Specifically, a small spring 11 is provided between the button 12 and the threaded end 7. The small spring 11 is configured to provide reset elasticity for the button 12 and can rotate together with the threaded end 7. The small spring 11 is usually made of phosphor bronze to ensure good elasticity and fatigue resistance.

In fact, in addition to springs, elastic members such as elastic silicone can also be used instead of the small spring 11 to fulfill the same function. The elastic silicone has good elasticity and flexibility, and can be customized to a sheet shape or a cylindrical shape depending on the space between the button 12 and the threaded end 7, so as to better play its elastic role.

In addition, from the perspective of broad elastic members in a broad sense, elastic bands, airbags, etc., can also be used. In the use of an elastic band, high-strength elastic fiber material can be chosen, the button 12 and the threaded end 7 are connected through a reasonable winding way, and the button 12 can be reset using the expansion and contraction characteristics of the elastic band. In the use of an airbag, the airbag can be disposed under the button 12, and the airbag is compressed by pressing the button 12 and rebounds upon the releasing to drive the button 12 to reset.

Working principle: before cosmetics are used, the button 12 can be pressed with a finger, the button 12 squeezes the lifting seat 9 inside the inner cap 4 through an elastic cantilever beam structure to move downward. In this case, the outer convex points 18 on the outer wall of the lifting seat 9 slide along the limit groove 19 in the inner wall of the inner cap 4 to prevent the lifting seat 9 from rotating. At the same time, the inner convex points 10 on the inner wall of the lifting seat 9 squeeze the thread groove in the threaded end 7, so that the handle 5 rotates. The handle 5 can drive the stirring ring 15 in the bottle body 1 to rotate through the rib 13, so as to stir the cosmetic cream. As the finger is released, the lifting seat 9 and the button 12 can be reset through the elasticity of the large spring 8 and the small spring 11 (or elastic members such as elastic silicone, elastic bands, and airbags), at the same time, the stirring ring 15 will reverse, thereby further stirring the cosmetic cream. In this way, an even stirring operation can be completed. After an even stirring, the outer cap 3 can be rotated to drive the inner cap 4 to separate from the bottle body 1, so as to facilitate the application of makeup. During stirring, the different designs of the stirring blades 17, such as movable stirring blades automatically adjusting the angle according to the resistance of the cream, multi-layer stirring blades enhancing the comprehensiveness of the stirring, etc., can more efficiently stir the cosmetic creams of different textures and ensure the homogeneity of the creams.

### Embodiment 2

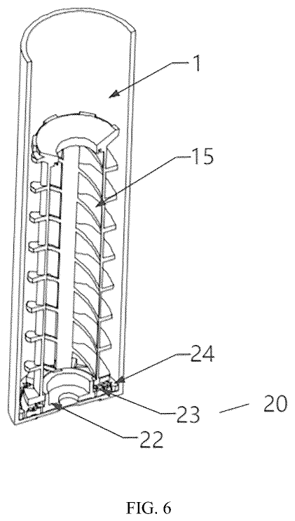

As shown in FIG. 6, the structure of the cosmetic bottle is the same as that in Embodiment 1, but a bottom stirring wheel 20 is placed inside the bottle body 1. The bottom stirring wheel 20 is disposed at the bottom of the bottle body 1. Connecting clamps 21 are provided at the bottom of the stirring ring 15 and embedded in the bottom stirring wheel 20. The stirring ring 15 rotates to drive the bottom stirring wheel 20 to rotate synchronously.

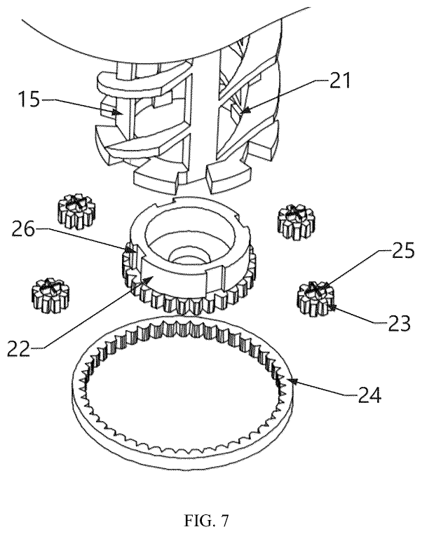

Specifically, as shown in FIG. 7, the bottom stirring wheel 20 includes a driving wheel 22, planetary rotating wheels 23, and an internal gear 24. The driving wheel 22 is provided with embedding grooves 26, and the connecting clamps 21 are embedded in the embedding grooves 26. The driving wheel 22 is disposed inside the internal gear 24. The planetary rotating wheels 23 are disposed between the driving wheel 22 and the internal gear 24, and the planetary rotating wheels 23 are meshed with an outer tooth surface of the driving wheel 22 and an inner tooth surface of the internal gear 24, respectively. In the traditional stirring mode, due to the stirring structure and hydrodynamic characteristics, the bottom region of the bottle body 1 often becomes a blind spot that is difficult to reach by stirring, which easily leads to the phenomenon that the cosmetic cream in the region is precipitated, layered, or mixed insufficiently. The introduction of the bottom stirring wheel 20, especially through the meshing structure constructed based on the mechanical transmission principle between the planetary rotating wheels 23 and the driving wheel 22 and the internal gear 24, effectively expands the coverage of the stirring operation, so that the stirring can be carried out in all directions without dead angles in all areas of the bottom of the bottle body 1. The driving wheel 22 generates a rotational motion under the drive of the stirring ring 15, and drives, based on the gear transmission mechanism, the planetary rotating wheels 23 to carry out a planetary motion inside the internal gear 24. Such planetary motion mode enables the planetary rotating wheels 23 to exert force on the cream at the bottom from a plurality of dimensions and a plurality of directions, realizing multi-directional stirring of the cream at the bottom. In this way, problems such as ingredient separation and uneven mixing of the cream at the bottom due to long standing are effectively avoided, ensuring high consistency of the cosmetic cream in terms of texture and ingredient distribution within the entire bottle body 1, and providing the user with a product of stable quality. The stirring ring 15 is mainly responsible for stirring the cosmetic cream in the middle and upper part of the bottle body 1, while the bottom stirring wheel 20 focuses on efficient stirring of the cream at the bottom of the bottle body 1. The above two are complementary in space and synchronized in time, which significantly shortens the time required for the cosmetic cream to reach a homogeneous mixing state. In particular, for the ingredients that tend to gather at the bottom and have a thick texture due to differences in density, greater viscosity, etc., the bottom stirring wheel 20, by virtue of its unique mechanical structure and movement, can quickly break up these gathered thick ingredients and cause them to be adequately mixed with other portions of the cream.

Further, the planetary rotating wheels 23 are each provided with a spur 25 on a side away from the bottom of the bottle body 1. When in a rotating state, the planetary rotating wheels 23 keep revolving while rotating, and the spurs 25 thereof will induce a localized turbulent flow phenomenon in the cream. Such localized turbulent flow can further destroy the relatively stable structure inside the cream, and promote more intense interaction and mixing between the ingredients inside the cream. Moreover, the localized turbulent flow generated by the spurs 25 and the turbulent flow induced by the stirring blades in the middle and upper part form a synergistic effect, which can fully stir the cream from different levels and different regions. The turbulent flow generated by the stirring blades in the middle and upper part mainly acts on a larger range of the cream to realize preliminary mixing at a macroscopic level; whereas the localized turbulent flow generated by the spurs 25 on the planetary rotating wheels 23 at the bottom focuses on a microscopic level of the cream at the bottom to carry out fine mixing of the cream at the bottom.

The above is only a preferred specific implementation of the present disclosure, but the protection scope of the present disclosure is not limited thereto. The replacement can be a replacement of part of the structures, devices, and method steps, or a complete technical solution. Any equivalent replacement or change based on the technical solution of the present disclosure and its disclosure concept should be included in the protection scope of the present disclosure.

What is claimed is:

1. A cosmetic bottle cream stirring and mixing structure, comprising a bottle body (1), cosmetic cream being contained in the bottle body (1), and an opening at an upper end of the bottle body (1) being provided with screw threads (2), wherein the upper end of the bottle body (1) is connected with a cap assembly;
the cap assembly is composed of an outer cap (3), an inner cap (4), and an elastic rotation structure, wherein the outer cap (3) is fixed to the inner cap (4) which is threadedly connected to the screw threads (2);
a stirring member passes through the bottle body (1) and the inner cap (4), the elastic rotation structure is disposed inside the inner cap (4), and the elastic rotation structure is configured to drive the stirring member to rotate back and forth, thereby stirring and mixing the cosmetic cream;
the elastic rotation structure comprises a large spring (8) sleeved on an upper end of the stirring member, an upper end of the large spring (8) is connected with a lifting seat (9), an upper end of the outer cap (3) is elastically connected with a button (12) configured to drive the lifting seat (9) to move downward, and the lifting seat (9) will not rotate during the movement and is threadedly connected to the upper end of the stirring member.

2. The cosmetic bottle cream stirring and mixing structure according to claim 1, wherein the stirring member comprises a handle (5), an upper end of the handle (5) is provided with a threaded end (7), a thread groove in an outer wall of the threaded end (7) is in contact with an inner convex point (10) on an inner wall of the lifting seat (9), and an outer convex point (18) on an outer wall of the lifting seat (9) is slidably connected to a limit groove (19) in an inner wall of the inner cap (4).

3. The cosmetic bottle cream stirring and mixing structure according to claim 2, wherein a brush (14) is provided at a lower end of the handle (5).

4. The cosmetic bottle cream stirring and mixing structure according to claim 3, wherein the handle (5) is provided with a rib (13) between the threaded end (7) and the brush (14), a stirring ring (15) is placed inside the bottle body (1), and the rib (13) is engaged with a groove (16) in an inner wall of the stirring ring (15).

5. The cosmetic bottle cream stirring and mixing structure according to claim 4, wherein a plurality of stirring blades (17) are provided on an outer peripheral surface of the stirring ring (15).

6. The cosmetic bottle cream stirring and mixing structure according to claim 5, wherein a sealing ring (6) is provided between the handle (5) and the inner cap (4).

7. The cosmetic bottle cream stirring and mixing structure according to claim 6, wherein a small spring (11) is provided between the button (12) and the threaded end (7).

8. The cosmetic bottle cream stirring and mixing structure according to claim 4, wherein a bottom stirring wheel (20) is also placed inside the bottle body (1) and disposed at the bottom of the bottle body (1), connecting clamps (21) are provided at the bottom of the stirring ring (15) and embedded in the bottom stirring wheel (20), and the stirring ring (15) rotates to drive the bottom stirring wheel (20) to rotate synchronously.

9. The cosmetic bottle cream stirring and mixing structure according to claim 8, wherein the bottom stirring wheel (20) comprises a driving wheel (22), planetary rotating wheels (23), and an internal gear (24); the driving wheel (22) is provided with embedding grooves (26), the connecting clamps (21) are embedded in the embedding grooves (26), the driving wheel (22) is disposed inside the internal gear (24), the planetary rotating wheels (23) are disposed between the driving wheel (22) and the internal gear (24), and the planetary rotating wheels (23) are meshed with an outer tooth surface of the driving wheel (22) and an inner tooth surface of the internal gear (24), respectively.

10. The cosmetic bottle cream stirring and mixing structure according to claim 9, wherein the planetary rotating wheels (23) are each provided with a spur (25) on a side away from the bottom of the bottle body (1).
